(19) United States
(12) Patent Application Publication
(10) Pub. No.: US 2026/0240625 A1
(43) Pub. Date: Aug. 20, 2026

(54) ORTHODONTIC APPLIANCE SYSTEMS AND METHODS OF MAKING SAME

(71) Applicant: Ormco Corporation, Brea, CA (US)

(72) Inventors: Mithil J Shah, North Hills, CA (US); Eugene Sirovskiy, Castro Valley, CA (US); Eric J. Ton, Methuen, MA (US)

(21) Appl. No.: 19/469,613

(22) PCT Filed: Mar. 28, 2024
(86) PCT No.: PCT/US2024/021919

§ 371 Date: Sep. 26, 2025

Related U.S. Application Data
(60) Provisional application No. 63/492,635, filed on Mar. 28, 2023.

(51) Int. Cl. A61C 7/08

(52) U.S. Cl. CPC A61C 7/08

(57) ABSTRACT

An orthodontic appliance system for orthodontic treatment of teeth. The system includes a template with a cavity. An attachment is removably received in the receptacle and has a surface including a bonding surface. A method of manufacturing includes constructing a scaffold assembly including a base and placing a template in contact with the scaffold assembly. The method includes inserting the attachment into the receptacle. During separating, the attachment remains coupled to the template in the receptacle. A method of manufacturing includes providing a mold of the patient's teeth. The mold including at least one projection and a through-passage. The method includes placing a container of dental composite in fluid communication with the through-passage, placing a template over the at least one projection, injecting dental composite from the container through the through-passage and into the receptacle, and removing the template from the at least one projection with the filled receptacle.

### CROSS REFERENCE TO RELATED APPLICATION

This application is a 371 National Stage of International Patent Application No. PCT/US2024/021919, filed on Mar. 28, 2024, which claims priority to U.S. Patent Application No. 63/492,635, filed Mar. 28, 2023, the disclosures of which are incorporated by reference herein in their entireties.

### TECHNICAL FIELD

The present invention relates generally to orthodontic appliances for orthodontic treatment and, more particularly, to orthodontic appliance systems including a plurality of orthodontic appliances and methods of making orthodontic appliances and systems.

### BACKGROUND

Orthodontics is the practice of manipulating teeth to correct malocclusions between the teeth of the upper and lower dental arches. Typically, treatment of malocclusions includes the use of an orthodontic appliance that applies corrective forces to the teeth. Over time, these corrective forces coerce the teeth to move into their orthodontically correct positions.

One way of applying corrective forces is with orthodontic appliances referred to as aligners. Aligners are supplied as a series of removable appliances that incrementally reposition the patient's teeth from their initial orientation to their orthodontically correct orientation. Patients being treated with aligners can insert and remove the aligners at will. When one aligner has moved the teeth to at or near a final orientation for that aligner, the patient begins using the next aligner in the series according to a treatment plan, which is prescribed by a clinician.

To fabricate aligners, the clinician first obtains a computer model of the patient's dentition. This model may be generated from data by taking an impression of the dentition and scanning the impression into a computer. Alternatively, the data may be generated by directly scanning the patient's teeth with an intraoral scanner. In either case, the scanned data is then used to construct the computer model of the patient's dentition.

Once the computer model has been obtained, the orthodontist may manipulate individual teeth in the computer model to determine a final orientation of each tooth that provides a corrected dentition. Multiple computer models may then be generated, with each model corresponding to an initial orientation, one or more intermediate orientations, or a final, desired orientation of the dentition. The clinician choreographs the movements of the teeth from the initial orientation through each of the intermediate orientations to the final, desired orientation. This predetermined movement is referred to as a treatment plan.

Given that some teeth are moved over greater distances than is possible with a single aligner, the treatment plans are often divided into numerous incremental stages of movement. Tooth movement during each stage is often achieved with a single aligner. Each stage may correspond to one computer model of the patient's teeth at a particular orientation.

Once the treatment plan is designed with the series of computer models corresponding to the stages of tooth movement, the series of aligners corresponding to the series of models may be manufactured. A mold is first fabricated from each model. An aligner is then be fabricated from the mold. In this way, the aligner may reflect the position of the patient's teeth according to one stage of treatment. Manufacturing each aligner in the series typically involves forming a plastic sheet over the mold constructed based on the patient's teeth at a particular stage of treatment according to the treatment plan. After forming, waste material in the sheet may be trimmed away to produce the aligner. Trimming may utilize CNC milling or another computer controlled cutting system.

During treatment with aligners, certain types of malocclusions may require use of specialized appliances at one or more periods of the treatment plan. These specialized appliances are incorporated in the models and become one element in the treatment plan and are designed to cooperate with the aligners to produce tooth-moving forces that are not possible with the aligner alone.

One type of appliance is an attachment. An attachment is an object that is placed on the tooth surface and projects outwardly therefrom. As such, the attachment essentially provides additional surfaces by which the orthodontist can engage with an aligner to manipulate the patient's teeth. Typically, attachments may be formed from a dental composite that self-adheres to the tooth as the composite cures. For example, attachments can be formed by hand by a clinician. In that regard, the clinician selects an attachment material to be used and fills a cavity with the selected material. The cavity defines the desired shape of the attachment and may be formed in a template of the patient's teeth. Once the material sets or hardens, the attachment takes on the shape of the cavity. The template fits snuggly over the teeth and positions the attachment at the desired location on the patient's tooth. The cavity in the template in combination with the tooth surface forms the shape of the attachment.

Before using a template, at the beginning of one stage of treatment, the clinician may prepare the surfaces of selected teeth for the attachment. Once the teeth are prepared, the clinician fills each of the cavities in the template with a dental composite. With each of the cavities filled, the clinician places the template over the patient's teeth. As the dental composite cures, it adheres to the surface of the teeth at a location specified by the template. The shape of the dental composite corresponds to the shape of the cavity in the template on the tooth surface. This process results in the attachment, i.e., cured dental composite, being adhesively secured to a surface of a patient's tooth. Attachments are temporary appliances. They may be usable for a predetermined period of time that is less than the entirety of the treatment plan, that is, fewer than all stage of treatment. Attachments are not typically removable by the patient.

Once the attachment is on the selected tooth, one or more of the aligners includes a receptable in which the attachment is at least partially received when the aligner is inserted onto the patient's jaw. During treatment, one or more of the aligners may forcibly engage the attachment to impart forces on one or more teeth according to the treatment plan.

While attachments are successfully used with aligners, there remain problems with their placement and use. Improved orthodontic appliance systems are needed that ease orthodontic treatment and improve treatment predictability during treatment with aligners.

### SUMMARY

In one aspect of the disclosure, there is an orthodontic appliance system for orthodontic treatment of a patient's teeth. The system includes a template including a shell with at least one cavity configured to receive a tooth. The shell has a plurality of walls defining the at least one cavity. The plurality of walls are configured to conform to at least portions of one or more surfaces of the tooth. At least one of the plurality of walls includes a receptacle that is open to the at least one cavity. An attachment is removably received in the receptacle and has one or more surfaces including a bonding surface. The bonding surface is exposed to the at least one cavity and is for bonding to the tooth.

In one embodiment, the attachment is solid object.

In one embodiment, the at least one of the plurality of walls is a labial wall.

In one embodiment, the system further includes an aligner configured to apply tooth-moving forces to the tooth. The aligner includes a shell with at least one cavity configured to receive the tooth. The shell has a plurality of walls defining the at least on cavity. The plurality of walls is configured to conform to at least portions of one or more surfaces of the tooth. At least one of the plurality of walls includes a receptacle that is open to the at least one cavity and is configured to receive the attachment when the attachment is bonded to the tooth. The shell of the aligner differs in a location of at least one wall of the plurality of walls relative to a corresponding wall of the plurality of walls of the template.

In one embodiment, the system further includes an etching template in which a shell with at least one cavity is configured to receive the tooth. The shell has a plurality of walls that define the at least one cavity. The plurality of walls is configured to conform to at least portions of one or more surfaces of the tooth. At least one of the plurality of walls includes a window through which a surface of the tooth is accessible when the etching template is placed on the tooth.

In one aspect of the disclosure, there is a method of manufacturing a template for use in orthodontic treatment of a patient's teeth. The method includes providing a mold of the patient's teeth. The mold has at least one projection in the shape of at least one of the patient's teeth. The method includes securing an attachment to the at least one projection and includes forming a worksheet over the at least one projection and over the attachment to form a deformed area in the worksheet. The deformed area has a plurality of walls that define at least one cavity configured to receive the patient's tooth and a receptable. The method includes removing the worksheet from the at least one projection with the at least one attachment being retained in the receptacle.

In one embodiment, prior to securing the attachment, the method further includes providing the attachment and placing the attachment on a patient setup card at a location on the patient setup card that corresponds to the at least one of the patient's teeth in the patient's mouth.

In one embodiment, prior to securing the attachment, the method further includes providing the attachment and applying an adhesive to the attachment, and securing the attachment to the at least one projection includes adhesively bonding the attachment to the at least one projection.

In one embodiment, prior to securing the attachment, the method further includes providing the attachment, placing the attachment on a patient setup card at a location on the patient setup card that corresponds to the at least one of the patient's teeth, picking the attachment from the location, and applying an adhesive to the attachment. In the embodiment, securing the attachment to the at least one projection includes adhesively bonding the attachment to the at least one projection.

In one embodiment, prior to securing the attachment, the method further includes 3-D printing the attachment.

According to one aspect of the disclosure, a method of manufacturing an orthodontic appliance system for use in orthodontic treatment of a patient includes constructing a scaffold assembly including a base, one or more pillars and/or spars extending from the base, and an attachment extending from the one or more pillars and/or spars. The method further includes placing a template in contact with the scaffold assembly. The template includes a first shell with at least one cavity configured to receive a tooth. The first shell has a plurality of walls defining the at least one cavity. The plurality of walls is configured to conform to at least portions of one or more surfaces of the tooth. At least one of the plurality of walls includes a receptacle that is open to the at least one cavity. In the method, placing includes inserting the attachment into the receptacle and separating the attachment from the one or more pillars and/or spars. During separating, the attachment remains coupled to the template in the receptacle.

In one embodiment, constructing the scaffold assembly includes 3-D printing the scaffold assembly.

In one embodiment, one or more pillars and/or spars extend at a non-orthogonal angle relative to the base.

In one embodiment, placing the template includes orienting the template at a nonorthogonal angle relative to the base so that the attachment is received in the receptacle.

In one embodiment, placing the template includes temporarily adhesively bonding the attachment in the receptacle.

In one embodiment, the scaffold assembly includes a weakened region between the attachment and the one or more pillars and/or spars and separating includes disconnecting the one or more pillars and/or spars from the attachment at the weakened region.

In one embodiment, separating includes cutting the one or more pillars and/or spars proximate the attachment.

In one embodiment, the method further includes providing a second shell with at least one cavity configured to receive the tooth. The second shell has a plurality of walls defining the at least one cavity. The plurality of walls is configured to conform to at least portions of one or more surfaces of the tooth. The method includes machining a window in at least one of the plurality of walls. The window is positioned to expose a surface of the tooth when the shell is positioned on the patient's teeth.

In one embodiment, the method further includes providing a plurality of aligners for use by the patient.

According to one aspect of the disclosure, a method of manufacturing an orthodontic appliance system for use in orthodontic treatment of a patient includes providing a mold of the patient's teeth. The mold has at least one projection in the shape of at least one of the patient's teeth. The at least one projection includes a through-passage. The method includes placing a container of dental composite in fluid communication with the through-passage and placing a template over the at least one projection. The template includes a shell with at least one cavity configured to receive a tooth. The shell has a plurality of walls defining the at least one cavity. The plurality of walls is configured to conform to at least portions of one or more surfaces of the tooth. At least one of the plurality of walls includes a receptacle that is open to the at least one cavity. In the method, placing includes positioning the receptacle in alignment with the through-passage, injecting dental composite from the container through the through-passage and into the receptacle, and removing the template from the at least one projection with the filled receptacle.

In one embodiment, injecting includes injecting a predetermined amount of dental composite into the receptacle.

In one embodiment, the method further includes placing a foil film over the filled receptacle.

In one embodiment, the method further includes placing the template in a lightproof container prior to shipment.

### BRIEF DESCRIPTION OF THE DRAWINGS

The accompanying drawings, which are incorporated in and constitute a part of this specification, illustrate embodiments of the invention and together with the detailed description given below, serve to explain various aspects of the invention.

FIG. 1A is a perspective view of one embodiment of a template of an orthodontic appliance system for orthodontic treatment of a patient.

FIG. 1B is a cross sectional view of the template shown in FIG. 1A.

FIG. 2A is a perspective view of one embodiment of an aligner of an orthodontic appliance system for orthodontic treatment of a patient.

FIG. 2B is a cross sectional view of the aligner shown in FIG. 2A.

FIGS. 3 and 4 are perspective views illustrating use of the exemplary template shown in FIG. 1A.

FIG. 5 is a perspective view of a scaffold system and assembly of a template and attachments according to one embodiment of the invention.

FIG. 6 is a schematic illustration of patient set up cards for organizing attachments according to one embodiment of the invention.

FIGS. 7 and 8 are perspective views of one embodiment of manufacturing a template and pre-assembly of attachments according to one embodiment of the invention.

FIG. 9 is a cross-sectional view taken along section line 8 -8 of FIG. 8.

FIG. 10 is a perspective view of one method of manufacturing an template appliance according to one embodiment of the invention.

FIG. 11 is a partial cross-sectional view through one receptacle taken along section line 10 -10 of FIG. 10 and illustrating a method of filling a receptacle of the template with a dental composite.

FIG. 12 is a cross-sectional view through the template of FIG. 11 after filling with a foil cap over the receptacle.

FIG. 13 is a perspective view of an etching template according to one embodiment of the invention.

### DETAILED DESCRIPTION

Embodiments of the invention are directed to orthodontic treatment systems including a plurality of orthodontic appliances. Exemplary systems include one or more dental aligners, one or more attachments, and a template for placement of the attachment(s) on a patient's tooth. An attachment, when placed on the patient's tooth, and the aligner cooperate with one another during orthodontic treatment. This cooperation may facilitate additional or different forces on selected teeth according to a treatment plan. In some variants, the orthodontic treatment system includes an etching template to aid the clinician in preparing the patient's tooth for the attachment. In any respect, the orthodontic treatment system is usable for orthodontic treatment of the patient. In some embodiments, such as an orthodontic treatment system including an aligner and an attachment, the aligner and the attachment are configured to be usable together during orthodontic treatment. In other embodiments, the appliances are configured to be used in series, in other words, one after another, with or without other appliances. For example, in orthodontic treatment system including a template, an attachment, and an aligner, the template is utilized to place the attachment on the patient's teeth and the aligner in cooperation with the attachment provide orthodontic treatment. The template and the aligner are not utilized together, but each serves a particular purpose in the orthodontic treatment. Advantageously, orthodontic treatment systems according to the embodiments of the invention improve orthodontic treatment predictability.

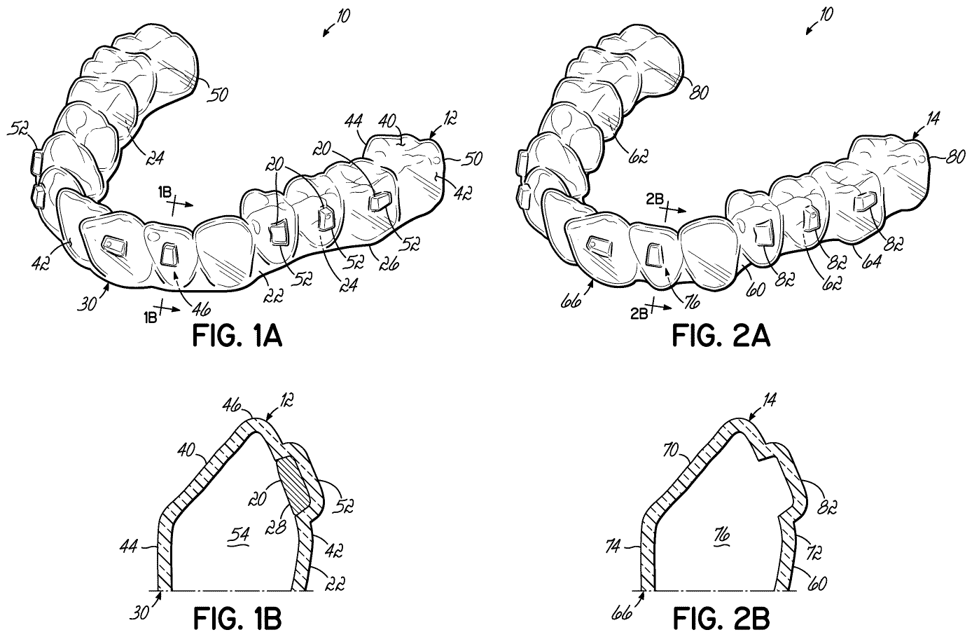

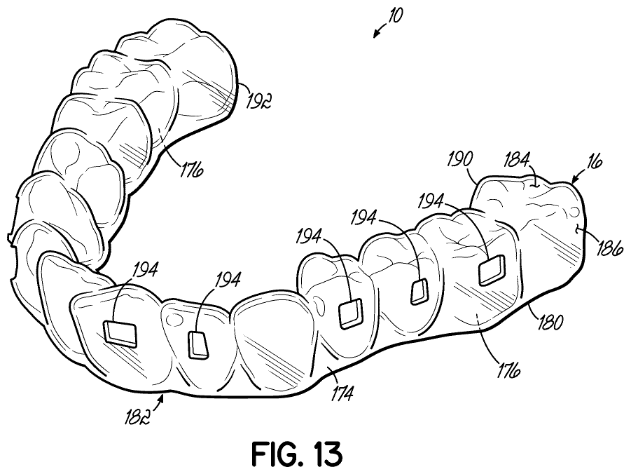

To those and other ends, and referring to FIGS. 1A and 2A, in an exemplary embodiment, an orthodontic appliance system 10 includes a template 12 (FIG. 1A), one or more attachments 20 (FIG. 1B), and one or more dental aligners 14 (FIG. 2A). As shown, the template 12 and the aligner 14 have similar visual appearance. Yet, the template 12 and the aligner 14 are designed to provide different functions in orthodontic treatment of a patient, as is described below. Exemplary embodiments of the orthodontic appliance system 10 may include only the template 12 and the attachments 20 (without the aligners 14). Another exemplary embodiment of the orthodontic appliance system 10 includes the template 12, one or more attachments 20, one or more dental aligners 14, and an etching template 16. An exemplary embodiment of the etching template 16 is described below with reference to FIG. 13.

With reference to FIGS. 1A and 1B, the attachment 20 is preassembled with the template 12 prior to receipt by the orthodontist. The clinician may then use the template 12 to position and secure the attachments 20 to the patient's teeth. The attachment 20 is designed to be attached to a patient's tooth and so separates from the template 12 when the template 12 is positioned over the patient's teeth. In exemplary embodiments, the attachment 20 is a solid object and, by way of example and not limitation, may be consist of a polymer. The attachment 20 has a 3-D (e.g., cube, cuboid, prism, or pyramid) shape. Further, the 3-D shape may be regular or irregular. As such, the attachment 20 has a plurality of surfaces, such as planar surfaces, intersecting one another at edges, and the edges may intersect forming vertices. One of the surfaces is a bonding surface 28 by which the attachment 20 is bonded to the tooth surface. In other exemplary embodiments, the attachment 20 may be uncured dental composite that is cured following use of the template 12 to form a cured dental composite on the patient's teeth. Uncured dental composite is not a solid object but solidifies as it cures to form a solid object. As an example of preassembly, the template 12 and one or more attachments 20 or a dental composite that may be cured to form the attachment 20, may be assembled during manufacturing, or immediately following manufacturing but prior to shipment of the template 12 to the clinician.

Pre-assembly of the attachments 20 (or an uncured dental composite) with the template 12 is advantageous. Generally, a process by which the clinician manually fills receptacles in a template with a dental composite is thereby avoided. In other words, the clinician need not first prepare the template by filling it with dental composite. Preassembly therefore reduces the orthodontist's time and limits or eliminates overfilling of a template with an excess amount of dental composite. Eliminating overfill avoids the necessity of flash cleanup from a patient's tooth following securing an attachment to the tooth and so saves the clinician's time. Flash results from excess composite that flows beyond a predetermined boundary of the attachment on the tooth surface. If not removed by the clinician during a cleanup step, flash can trap food debris adjacent the tooth surface. Overfilling can also cause distortion of the attachment once the composite is cured. And further, on the opposite end of spectrum, preassembly of the attachment 20 with the template 12 also eliminates the possibility of underfilling of a template with dental composite. In this case, the resulting attachment is improperly formed. An improperly formed attachment may result in a deformed attachment. In the case of a distorted or deformed attachments, each lacks the desired configuration for proper treatment. As a result, the desired forces on the tooth during orthodontic treatment may not be achieved. By avoiding these formation problems, and according to embodiments of the present invention, attachments 20 are more precisely formed so that subsequent orthodontic treatment with the aligners 14 is more consistent and more predictable.

In embodiments of the present invention, the template 12 is designed to position each attachment 20 at the correct orientation and location on the patient's teeth. The template 12 includes a hollow shell 22 that is configured to encapsulate one or more crowns of a patient's teeth. The shell 22 may be an elastic material that is soft and flexible and so have a rubber-like elasticity. In one embodiment, the elastic material of the shell 22 is unlike the material of the aligner 14. The elastic property enables the template 12 to be placed over the patient's teeth and then easily removed without disturbing the attachments 20 once they are attached to the patient's teeth. Unlike the aligner 14 (described below), the template 12 does not apply tooth-moving forces to the patient's teeth.

In the exemplary embodiment shown in FIGS. 1A and 1B, the shell 22 is formed with a plurality of cavities 24 that collectively define an edge 26. Each cavity 24 may be shaped to receive a specific one of the patient's teeth. The edge 26 defines an opening 30 in the shell 22 and defines a gingival edge of the shell 22. The patient's teeth are received into their respective cavities 24 through the opening 30.

To conform to the patient's teeth, the shell 22 has wall portions that contact some of the surfaces of the patient's teeth and define the cavities 24. By way of example, the wall portions include an occlusal wall 40, a labial wall 42, and a lingual wall 44. In FIG. 1B, the walls 40, 42, 44 are shown with respect to the anterior tooth cavity 46. The shell 22 may also include distal portions 50 that encircle the cavities 24 that receive the rear-most molar teeth. When the cavities 24 receive the patient's teeth, walls 40, 42, 44, and 50 generally conform to the corresponding surfaces of a respective one of the patient's teeth with the edge 26 positioned proximate the patient's gingiva.

With reference to FIGS. 1A and 1B, in one embodiment, the shell 22 includes one or more receptacles 52 formed in the labial wall 42. The receptacles 52 may appear as a bubble in the wall 42 and is formed by a 3-D protrusion in the wall 42 outwardly away from the surrounding wall. The wall 42 at the receptacle 52 therefore does not conform to the tooth surface when the template 12 is placed on the patient's teeth. Instead, the receptacle 52 creates a void space between the wall 42 and the tooth surface. In the exemplary embodiment shown in FIG. 1A, the template 12 includes seven receptacles 52. Each of those receptacles 52 is formed in the labial wall 42. The receptacles 52 open to the respective cavities 24. Embodiments of the invention are not limited to the template 12 having seven receptacles 52, as shown. It is contemplated that more or fewer receptacles 52, for example, one receptacle 52, may be utilized. Moreover, receptacles 52 may formed on the lingual wall 44 (or distal wall 50) of the shell 22 according to embodiments of the invention.

As an example, and with reference to FIG. 1B, the receptacle 52 opens to the cavity 54. The attachment 20 resides in the receptacle 52 and may be flush with an inner surface of the labial wall 42, as shown. In this way, when the template 12 receives the patient's teeth, the bonding surface 28 of the attachment 20 is available to contact a tooth in the cavity 54. Once placed on the patient's tooth, the attachment 20 is available for contact with the aligner 14 to move specific ones of the patient's teeth according to a treatment plan.

Referring now to FIGS. 2A and 2B, an exemplary embodiment of the orthodontic appliance system 10 further includes one or more aligners 14. The template 12 and attachments 20 and the aligner(s) 14 may form an exemplary set of orthodontic appliances that are shipped to the clinician for use. By way of example, once the template 12 is utilized to secure the attachments 20 to the patient's teeth, the aligner 14 may be coupled to the patient's jaw so that orthodontic treatment can begin.

In that regard, the aligner 14 is designed to move the patient's teeth according to a treatment plan in conjunction with the attachments 20. The aligner 14 includes a hollow shell 60 that is configured to encapsulate one or more crowns of a patient's teeth and the attachments 20. The shell 60 may be an elastic material, such as a thermoplastic material, in one or more layers and is capable of generating tooth-moving forces when elastically deformed. Similar to the shell 22 of the template 12, the shell 60 of the aligner 14 is formed with a plurality of cavities 62 that collectively define an edge 64. Each cavity 62 may be shaped to receive a specific one of the patient's teeth. The edge 64 defines an opening 66 in the shell 60 through which the patient's teeth may be received into their respective cavities 62. As shown, the edge 64 of the aligner 14 may form a gingival edge of the shell 60 and have a scalloped appearance to trace the patient's gum line. In comparing FIG. 1A with FIG. 2A, the edge 64 of the aligner 14 differs in its configuration from the edge 26 of the template 12, which is more linear and less scalloped.

With reference to FIG. 2B, to conform to the patient's teeth, the shell 60 has wall portions that contact some of the surfaces of the patient's teeth. By way of example, the wall portions include an occlusal wall 70, a labial wall 72, and a lingual wall 74. The shell 60 may also include distal walls 80 (labeled in FIG. 2A) that encircle the cavities 62 that receive the patient's rear-most molar teeth. In FIG. 2B, the walls 70, 72, 74 are shown with respect to the anterior tooth cavity 76. When received on the patient's teeth, walls 70, 72, and 74 of each cavity 62 generally conform to the corresponding surfaces of a respective one of the patient's teeth with the edge 64 positioned proximate the patient's gingiva. Although the template 12 shown in FIG. 1A and the aligner 14 shown in FIG. 2A appear similar in the location of walls 40, 42, 44, 50 and walls 70, 72, 74, and 80, generally the configuration of the two can differ significantly, particularly as treatment progresses, because the walls 70, 72, 74, and 80 in a series of aligners 14 change orientation in accordance with the desired tooth movement. Furthermore, a thickness of the shell 22 of the template 12 and a thickness of the shell 60 of the aligner 14 are not necessarily equal, as is shown.

In one embodiment, the shell 60 of the aligner 14 includes one or more receptacles 82 formed in the labial wall 72. At each receptacle 82, the wall 72 deviates from conforming to the respective tooth so as to receive the attachment 20. The receptacle 82 therefore forms a void space (in the absence of an attachment 20) that opens to the respective cavity 62. As an example, and with reference to FIG. 2B, the receptacle 82 opens to the cavity 76. In the exemplary embodiment shown in FIG. 2A, the aligner 14 includes seven receptacles 82. Each of the receptacles 82 may have a different configuration but in general have a regular orthogonal configuration including one or more surfaces and edges that are not typically found on a tooth. One or more of the surfaces and edges of the attachment 20 are configured to cooperate with one or more of the surfaces and edges of the receptacle 82. In the exemplary embodiment, each of the receptacles 82 conforms to the size and shape of the receptacles 52 of the template 12 shown for example in FIG. 1A. In one embodiment, the receptacles 82 are the same size and shape as receptacles 52 of the template 12 and so conform to the configuration of the corresponding attachment 20.

In the exemplary embodiment, there are seven receptacles 82, each of which is formed in the labial wall 72 of the shell 60. Embodiments of the invention are not limited to the aligner 14 having seven receptacles 82, though the number of receptacles 82 in the shell 60 may be at least equal to the number of attachments 20 on the patient's teeth. It is contemplated that more or fewer receptacles 82, for example, one receptacle 82, may be utilized for a single attachment 20. Moreover, receptacles 82 may be formed on the lingual wall 74 of the shell 60 according to embodiments of the invention.

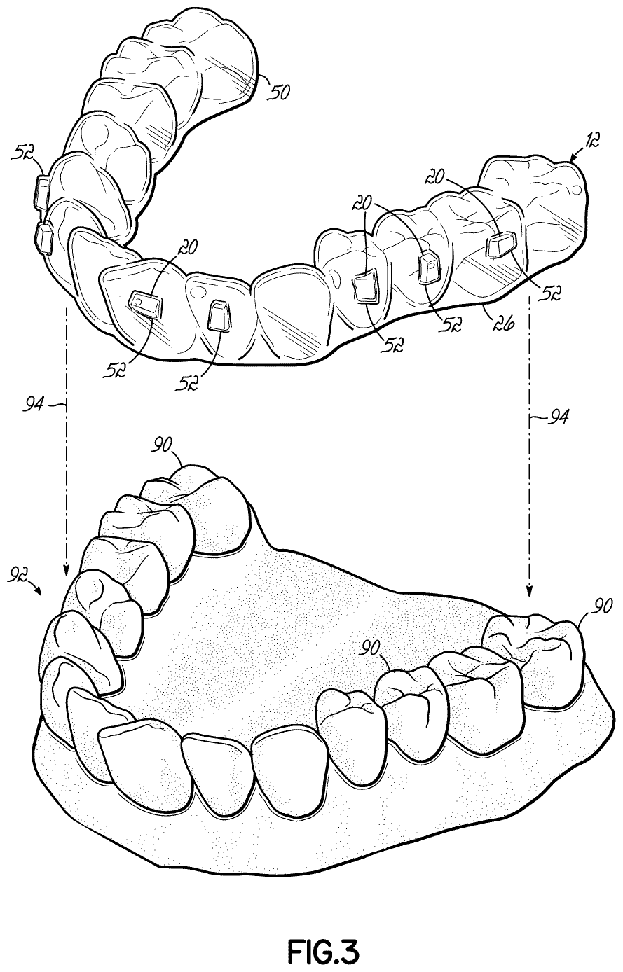

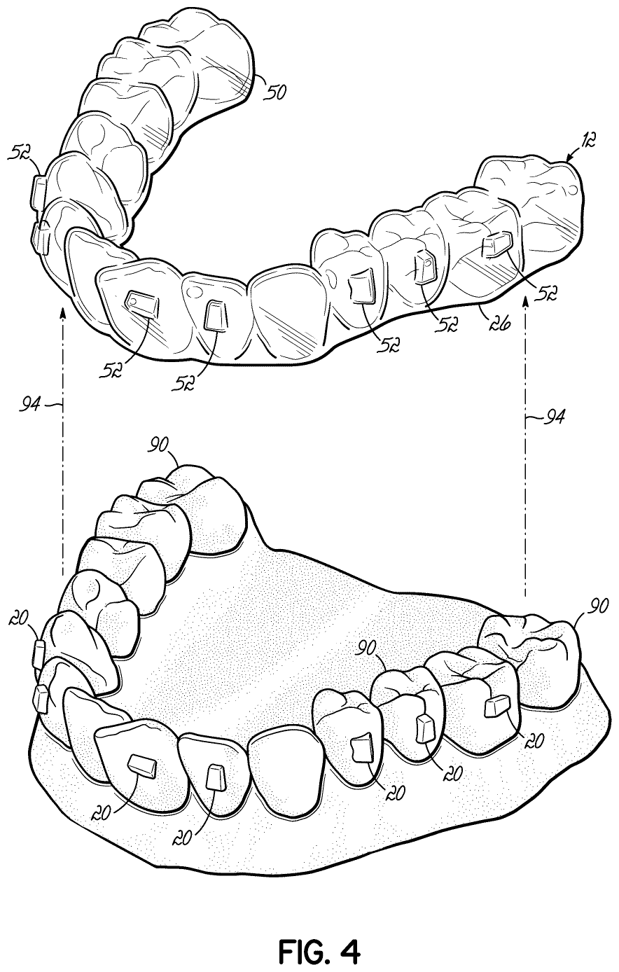

Referring to FIGS. 3 and 4, in preparation for orthodontic treatment, the clinician positions the template 12 over a plurality of teeth 90 in a patient's jaw 92 as indicated by arrows 94. Although not shown, once the template 12 is positioned on the patient's teeth 90, the attachments 20 in each of the receptacles 52 are secured to respective one of the teeth 90. The clinician then removes the template 12, as is shown in FIG. 4.

When the template 12 is removed as indicated by arrow 94, the attachments 20 remain secured to the respective patient's teeth 90. Although the patient's of the jaw is not shown, the same procedure may be carried out on the patient's other jaw. According to one embodiment, the attachments 20 may be adhesively secured to the patient's teeth. After the attachments 20 are secured to the patient's teeth 90, the patient couples one of the aligners 14 to their teeth and orthodontic treatment begins according to the prescribed treatment plan. At the end of treatment, or when the attachments 20 are no longer needed, the clinician may remove them.

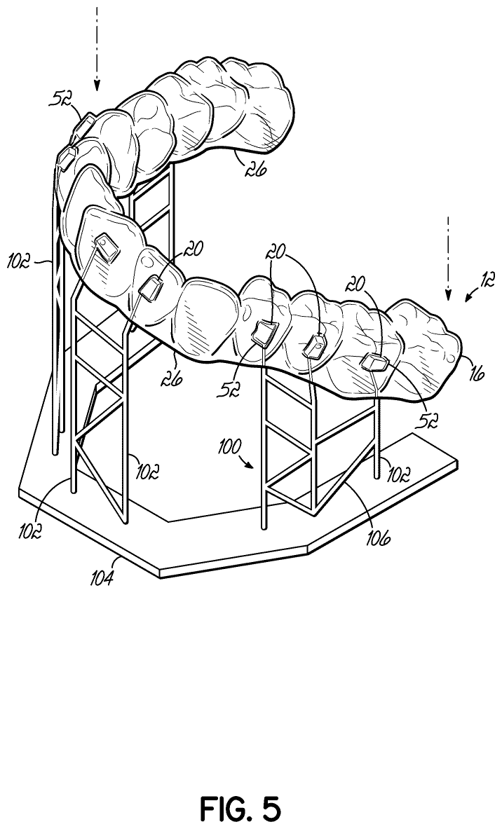

According to embodiments of the invention, the template 12 and the attachment 20 are preassembled prior to shipment to the clinician or the patient. With reference to FIGS. 5-11, exemplary manufacturing and preassembly of the attachments 20 with the template 12 are described. Referring to FIG. 5, in one embodiment, the attachments 20 are 3-D printed as part of a scaffold assembly 100. As shown, the scaffold assembly 100 includes one or more posts 102 that extend from the base 104. Spars 106 may extend between adjacent posts 102 to mechanically stabilize the posts 102. Individual ones of the attachments 20 are 3-D printed at an end of selected ones of the posts 102 and/or spars 106 in a predetermined orientation. The orientation of the posts 102 and/or spars 106 and the attachments 20 may facilitate insertion of the attachments 20 with a respective one of the receptacles 52 in the template 12.

In that regard, in the exemplary embodiment shown, the posts 102 may be of different heights relative to one another and/or form a non-orthogonal angle relative to the base 104. This is by design. Advantageously, 3-D printing the attachments 20 held in position by the posts 102 and/or spars 106 may facilitate printing of attachments 20 that would not otherwise be printable on a horizontal print surface. For example, attachments 20 that form undercuts or are reentrant when positioned on teeth may not be 3-D printable directly on a horizontal printer surface. With the scaffold assembly 100, however, the attachments 20 may be oriented in a manner that facilitates 3-D printing. And, 3-D printing of the attachments 20 is advantageous.

As an example, 3-D printing the attachment 20 eliminates the use of dental composite. In this way, harder, more durable materials than a dental composite may be selected for the attachment 20. By way of example, the attachment 20 may consist of one or more of methacrylate-based photo polymerized resin available from Dentca™, Torrance, California; Methyl Methacrylate Polymethyl methacrylate (MPM-PMMA) available from Heraeus Kulzer GmbH; CLC-PMMA-OFC available from GC Co.; Isosit (UDMA and inorganic fillers) from Ivoclar Vivadent AG; and PMMA with crosslinking of the polymer chains available from Candulor AG. It is believed that harder, more durable materials are advantageous, because they resist wear more effectively than dental composites. The attachments 20 according to embodiments of the invention resist losing their initial shape by becoming rounded during use. Force application from the aligners 14 is consequently maintained so that the patient's teeth move as predicted. Embodiments of the invention facilitate more efficient aligner-attachment force transfer over longer periods of time, because the attachments 20 may retain their designed shape longer. This facilitates more predictable orthodontic treatment. As a further advantage, 3-D printing permits the bonding surface of the attachments 20 to manufactured with a surface topology (e.g., a mesh) that there is a stronger bond developed between the attachment 20 and the tooth via the intervening adhesive.

In one embodiment, once the scaffold assembly 100 is completed, the template 12 is placed onto the scaffold assembly 100 with the attachments 20 inserted into the receptacles 52. As shown, the template 12 may be oriented in a particular nonorthogonal angle relative to the scaffold assembly 100 to orient each receptacle 52 for receipt of the attachment 20. A temporary adhesive (not shown) may hold the attachments 20 in the respective receptacle 52. The attachments 20 are then disconnected from the posts 102 and/or spars 106 at a localized weak area in the scaffold assembly 100 adjacent the attachment 20. In this regard, the attachment 20 may be snapped off the posts 102 and/or spars 106 leaving the attachment 20 adhesively received in the receptacle 52. Alternatively, the attachments 20 may be disconnected from the scaffold assembly 100 by cutting at a location at which the attachment 20 is connected to the post 102 and/or spars 106. The weakened area or cut location may be proximate the attachment 20 or correspond to the bonding surface 28 (FIG. 1B) by which the attachment 20 is secured to the patient's tooth. Following removal of the remainder of the scaffold assembly 100, adhesive may be applied to each base surface 28 of the attachment 20. The template 12 having preassembled attachments 20, with or without aligners 14, may then be shipped to the clinician or to the patient.

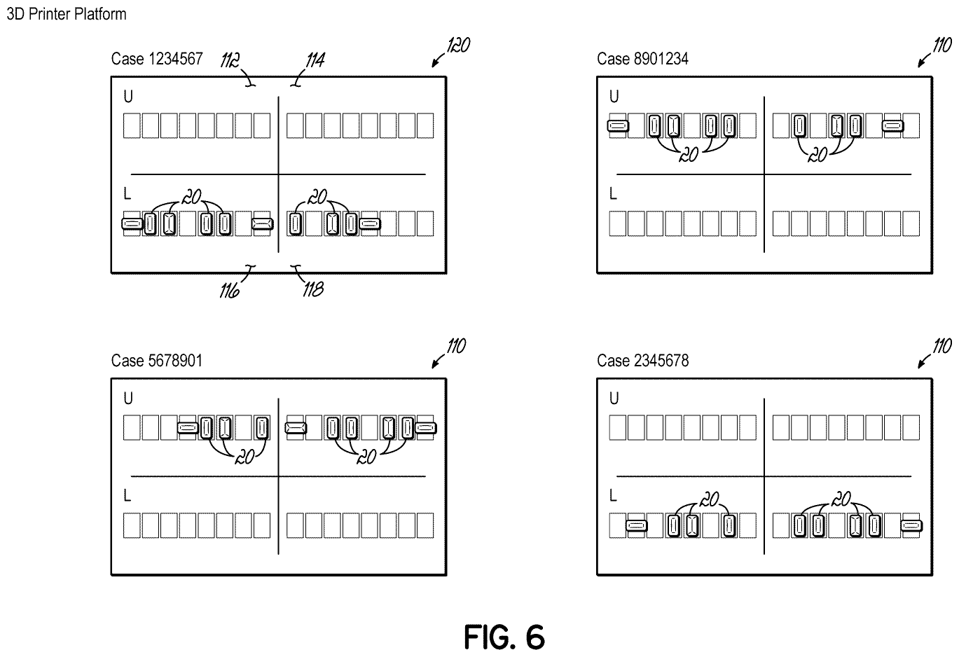

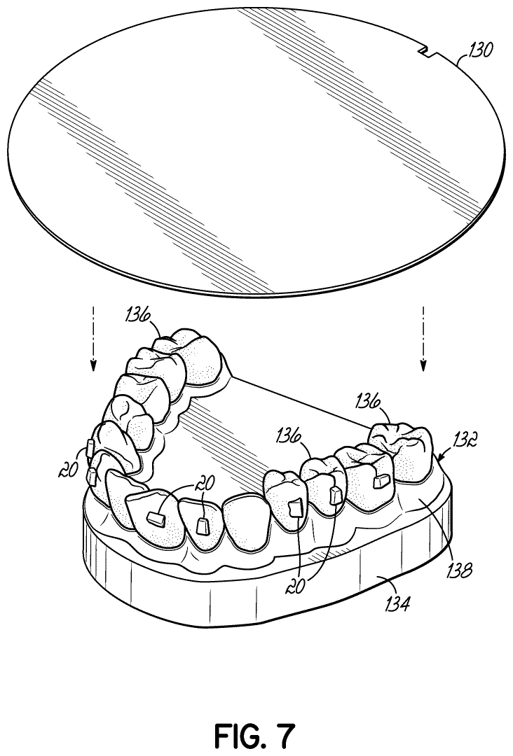

Referring now to FIGS. 6 and 7, in an alternative embodiment, the attachments 20 are 3-D printed either on a scaffold assembly 100 or on a surface and then transferred to a patient setup card 110. Exemplary materials from which the scaffold assembly 100 and the attachments 20 may be printed include, but are not limited to the same materials listed above, but namely, methacrylate-based photo polymerized resin available from Dentca™, Torrance, California; Methyl Methacrylate Polymethyl methacrylate (MPM-PMMA) available from Heraeus Kulzer GmbH; CLC-PMMA-OFC available from GC Co.; Isosit (UDMA and inorganic fillers) from Ivoclar Vivadent AG; and PMMA with crosslinking of the polymer chains available from Candulor AG. In FIG. 6, as an example of a process including 3-D printing of the attachments 20, the attachments 20 are printed and are then placed according to individual ones of the patient's teeth in quadrants 112, 114, 116, 118 in a human mouth. For example, with respect to the patient setup card 120, six attachments 20 are shown in lower left quadrant 116 and four attachments 20 are shown in lower right quadrant 118 while no attachments are shown on the upper jaw as indicated in quadrants 112 and 114. This arrangement ensures that the attachments 20 are properly placed.

With reference to FIG. 7, one embodiment of a process of forming the template 12 may include deforming a workpiece 130 with a mold 132. The mold 132 may be one of a series of molds each fabricated based on a corresponding computer model of the patient's dentition and each mold capturing a target orientation of the patient's teeth during orthodontic treatment. By way of example only and not limitation, the mold 132 shown in FIG. 7 may represent the patient's teeth prior to treatment. The mold 132 may include a base 134 that supports a plurality of projections 136 in the form of model teeth that extend from a model gum 138 (i.e., gingiva). As such, each model tooth 136 may have an orientation that is configured to produce a corresponding cavity 24 in the template 12. The model gum 138 ideally provides a limiting boundary for the location of the edge 26 of the template 12. The computer model used to manufacture the molds may be generated, for example, based on the patient's initial dentition and a computer model of the desired virtual movement of the patient's teeth. One or more of the molds 132 may be 3-D printed.

After printing the attachments 20 and placement of the attachments 20 on a setup card 110 according to FIG. 6, and after manufacturing the mold 132, in one embodiment of the invention, the attachments 20 may be taken from the patient setup card 110 and secured to a corresponding one of the teeth 136 of the mold 132. In that regard, a robot arm with a suction end effector (not shown) may be programmed to pick the attachments 20 from the setup card 110 and place them onto the corresponding tooth 136. During the pick and place process, an adhesive (not shown) may be coated onto the attachment 20. The adhesive may temporarily adhere the attachment 20 to the tooth 136 of the mold 132. Exemplary adhesives include LeGlue (i.e., a dextrin/polymer resin blend) commercially available from Le-Glue, Dalton, Georgia and Tecbond 2507 FS commercially available from Priddy Sales Company, Fort Worth Texas 76126.

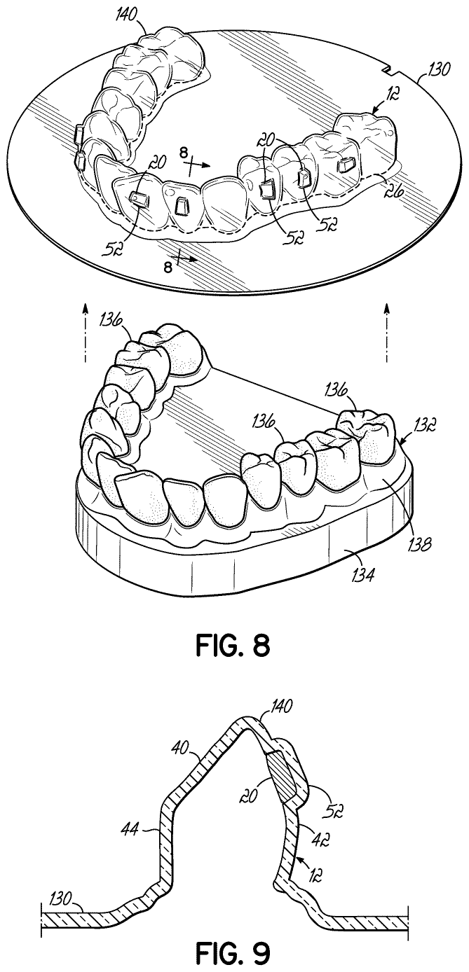

In one embodiment, after placement of the attachments 20 on the mold 132, the workpiece 130 is deformed over the mold 132 and over the attachments 20. The deformed workpiece 130 is shown in FIG. 8 with the workpiece 130 being removed from the mold 132. As shown, the workpiece 130 includes a deformed area 140 that corresponds to the template 12. During deforming or upon removal of the deformed area 140 from the mold 132, and the attachments 20 that were temporarily secured to the mold 132 are detached from the mold 132. The deformed area 140 is shown in cross section in FIG. 9. Thus, in one embodiment of the invention, the attachments 20 form the receptacles 52 in the template 12 while simultaneously being preassembled with the template 12. After deforming, the template 12 is separated from the remainder of the deformed workpiece 130 at a location that may correspond to the edge 26 (shown in dashed line in FIG. 8). Once separated, the template 12 is available for use in orthodontic treatment as is generally shown in FIGS. 3 and 4 and described above.

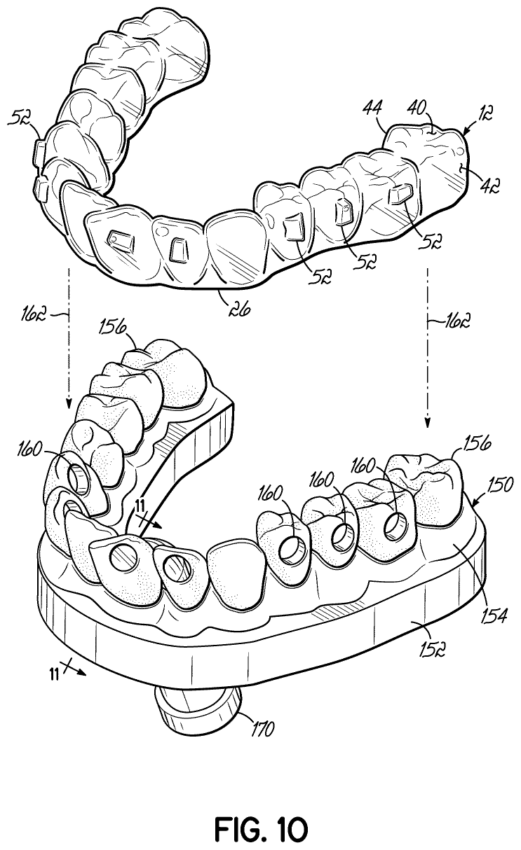

With reference now to FIGS. 10, 11, and 12, in one embodiment, a dental composite is injected into the template 12. In that regard, with reference to FIG. 10, a mold 150 similar in some respects to the mold 132 shown in FIG. 8 is utilized. The mold 150 may include a base 152 from which a model gingiva 154 and model teeth 156 extend. As shown selected ones of the model teeth 156 includes a through-passage 160 extending in a generally labial-lingual direction (or, in other words, from inside to outside of the selected ones of the model teeth 156). The through-passage 160 is formed at a location at which the attachment 20 is to be positioned on the patient's teeth. Although circular through-passages are shown, embodiments of the invention and are not limited to circular configurations as other configurations (e.g., rectangular, triangular, irregular etc.) are possible.

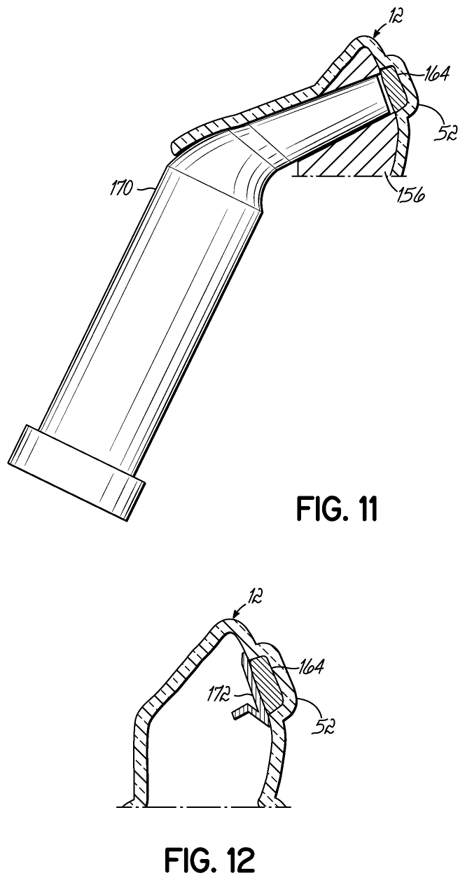

A previously formed template 12 including receptacles 52 corresponding to the selected ones of the model teeth 156 is coupled to the mold 150. This is indicated by arrows 162 in FIG. 10. Before or after the template 12 is coupled to the mold 150, and with reference to FIG. 11, a cartridge 170 is inserted into or through (as shown) the through-passage 160 of each of the selected ones of the model teeth 156. The cartridge 170 contains a predetermined amount of a dental composite. A calculated amount of the dental composite is injected from the cartridge 170 into the receptacle 52 through the through-passage 160. In one embodiment, the mold 150 or selected areas of the mold 150 including the through-passages 160 may be heated to enable more consistent flow of the dental composite during injections. In this way, the receptacle 52 is filled with a dental composite 164. The dental composite 164 later becomes the attachment when the composite is cured, usually with UV light after it is adhered to the patient's teeth.

In the exemplary embodiment, the filling process is then repeated for each receptacle 52. For example, the cartridge 170 is then moved to the next through-passage 160 and a calculated amount of the dental composite is injected into the next receptacle 52. The calculated amount of dental composite for each receptacle 52 may differ because each of the receptacles 52 may have a different volume and so require a different amount of composite to fill the volume. In this way, receptacle-by-receptacle, each of the receptacles 52 of the template 12 is filled with a precise amount of dental composite for that receptacle 52. Advantageously, by dosing a predetermined amount of material into each receptacle, overfilling and underfilling the receptacles 52 is avoided. In one embodiment, the cartridge 170 contains enough dental composite to fill just one of the receptacles 52. A new cartridge 170 may then be inserted into each of the through passages 160 and precise filling of each of the receptacles 52 may occur concurrently. Although not shown, in another exemplary embodiment, passages in the mold 150 are interconnected and extend from the model teeth adjacent the receptacles 52 to a single injection location. The passages therefore fan out from the single injection location to each receptacle 52. A single cartridge 170 may be inserted at the single injection location in the mold 150. Controlling the flow of the composite from the only cartridge 170 may provide precise control of filling of the receptacles 52.

Referring now to FIG. 12, in one embodiment, after the receptacle 52 is filled with dental composite 164, a foil cap 172 is placed over the dental composite 164 to prevent premature curing of the composite 164 prior to application of the composite on the patient's teeth. The template 12 with the composite filled receptacles 52 may be shipped in a light-proof container, such as a sealable foil bag, to prevent premature curing of the composite. The clinician or the patient removes the template 12 from the container and removes the foil cap 172 prior to application of the template 12 with composite filled receptacles 52 to the patient's teeth. This procedure is generally shown in FIGS. 3 and 4. After removal of the foil cap 172 and placement of the template 12 on the patient's teeth, the composite may be cured by exposing it to UV light or other curing source. Once cured, the composite forms the attachment 20. The template 12 may be removed from the patient's teeth before or after curing the composite 164.

In one embodiment, and with reference to FIG. 13, the orthodontic treatment system 10 may further include an etching template 16. The etching template 16 may be utilized prior to use of the template 12, described above with reference to FIGS. 1A and 1B and may be utilized prior to use of the aligner 14. In that regard, the etching template 16 may visually locate an area on the tooth surface at which an attachment is to be attached to the patient's tooth. The clinician may then utilize the etching template 16 as a guide to clean and prepare the tooth surface for the attachment 20. Generally, preparing the tooth surface includes etching a surface layer of the tooth with an etching solution. Once etched, an adhesive is better able to bond to the tooth surface. The etching template 16 may protect surfaces of the patient's teeth from being unintentionally exposed to etching solution.

In the exemplary embodiment shown, the etching template 16 includes a shell 174 that is similar in configuration to the configuration of the shell 22 of the template 12. In that regard, the shell 174 is formed with a plurality of cavities 176 that collectively define an edge 180. Each cavity 176 may be shaped to receive a specific one of the patient's teeth. The edge 180 defines an opening 182 in the shell 174 and defines a gingival edge of the shell 174. The patient's teeth are received into their respective cavities 176 through the opening 182.

To conform to the patient's teeth, the shell 174 has wall portions that contact some of the surfaces of the patient's teeth. By way of example, the wall portions include an occlusal wall 184, a labial wall 186, and a lingual wall 190. The shell 174 may also include a distal wall 192 that encircles the cavities 176 that receive the rear-most molar teeth. Each of the walls 184, 186, 190, and 192 may conform in location and in orientation to the corresponding walls 40, 42, 44, and 50 of the template 12. In this way, the etching template 16 is received on the patient's teeth in the same orientation as the template 12 is received on the patient's teeth.

With continued reference to FIG. 13, in one embodiment, the shell 174 includes one or more windows 194 formed in the labial wall 186 of the shell 174. Windows 194 are positioned at the location at which the receptacles 52 of the template 12 are to be located when the attachments 20 are secured to the patient's teeth. In the exemplary embodiment shown in FIG. 13, the etching template 16 includes seven windows 194. Each of those windows 194 is formed in the labial wall 186. The windows 194 open to the respective cavities 176 and are generally of the same shape as an area of the bonding surface 28 of the attachment 20 to the patient's tooth. The shape of the windows 194, however, are not limited to the rectangular shape shown. Further, embodiments of the invention are not limited to the etching template 16 having seven windows 194, as shown. It is contemplated that more or fewer windows 194, for example, one window 194, may be utilized. However, the windows 194 may be equal to the number of receptacles 52 in the template 12. Formation of windows 194 in the shell 174 is not particularly limited by any method. For example, the windows may be as-formed or machined (e.g., hole punched) in the shell 174.

In use, the etching template 16 is inserted onto the patient's teeth. The windows 194 are generally aligned with the location at which the attachment 20 is to be attached to the tooth. The clinician may then prepare the tooth surface at a specific area indicated by the window 194. Once each of the teeth is prepared, the etching template 16 is removed and according to embodiments of the invention, the template 12 is positioned on the patient's teeth. The attachments 20 (or the dental composite 164) are then adhered to the tooth at the prepared areas. Once the attachments 20 are adhered to the patient's teeth or after the dental composite 164 is cured, the template 12 is removed, and the aligner 14 is coupled to the patient's teeth so that orthodontic treatment may begin.

While the present invention has been illustrated by a description of various embodiments and while these embodiments have been described in some detail, it is not the intention of the inventors to restrict or in any way limit the scope of the appended claims to such detail. Thus, additional advantages and modifications will readily appear to those of ordinary skill in the art. The various features of the invention may be used alone or in any combination depending on the needs and preferences of the user.

What is claimed is:

1. An orthodontic appliance system for orthodontic treatment of a patient's teeth, the system comprising:
a template including a shell with at least one cavity configured to receive a tooth, the shell having a plurality of walls defining the at least one cavity, the plurality of walls being configured to conform to at least portions of one or more surfaces of the tooth, at least one of the plurality of walls includes a receptacle that is open to the at least one cavity; and
an attachment removably received in the receptacle and having one or more surfaces including a bonding surface, the bonding surface is exposed to the at least one cavity and is for bonding to the tooth.

2. The system of claim 1, wherein the attachment is solid object.

3. The system of claim 1, wherein the at least one of the plurality of walls is a labial wall.

4. The system of claim 1, further comprising:
an aligner configured to apply tooth-moving forces to the tooth, the aligner including a shell with at least one cavity configured to receive the tooth, the shell having a plurality of walls defining the at least on cavity, the plurality of walls being configured to conform to at least portions of one or more surfaces of the tooth, at least one of the plurality of walls includes a receptacle that is open to the at least one cavity and is configured to receive the attachment when the attachment is bonded to the tooth,
wherein the shell of the aligner differs in a location of at least one wall of the plurality of walls relative to a corresponding wall of the plurality of walls of the template.

5. The system of claim 1, further comprising:
an etching template including a shell with at least one cavity configured to receive the tooth, the shell having a plurality of walls defining the at least one cavity, the plurality of walls being configured to conform to at least portions of one or more surfaces of the tooth, at least one of the plurality of walls includes a window through which a surface of the tooth is accessible when the etching template is placed on the tooth.

6. A method of manufacturing a template for use in orthodontic treatment of a patient's teeth, the method comprising:
providing a mold of the patient's teeth, the mold having at least one projection in the shape of at least one of the patient's teeth;
securing an attachment to the at least one projection;
forming a worksheet over the at least one projection and over the attachment to form a deformed area in the worksheet, the deformed area having a plurality of walls defining at least one cavity configured to receive the patient's tooth and a receptable; and
removing the worksheet from the at least one projection with the at least one attachment being retained in the receptacle.

7. The method of claim 6, wherein prior to securing the attachment, the method further comprises:
providing the attachment; and
placing the attachment on a patient setup card at a location on the patient setup card that corresponds to the at least one of the patient's teeth in the patient's mouth.

8. The method of claim 6, wherein prior to securing the attachment, the method further comprises:
providing the attachment; and
applying an adhesive to the attachment,
wherein securing the attachment to the at least one projection includes adhesively bonding the attachment to the at least one projection.

9. The method of claim 6, wherein prior to securing the attachment, the method further comprises:
providing the attachment;
placing the attachment on a patient setup card at a location on the patient setup card that corresponds to the at least one of the patient's teeth;
picking the attachment from the location; and
applying an adhesive to the attachment,
wherein securing the attachment to the at least one projection includes adhesively bonding the attachment to the at least one projection.

10. The method of claim 6, wherein prior to securing the attachment, the method further comprises:
3-D printing the attachment.

11. A method of manufacturing an orthodontic appliance system for use in orthodontic treatment of a patient, the method comprising:
constructing a scaffold assembly including a base, one or more pillars and/or spars extending from the base, and an attachment extending from the one or more pillars and/or spars;
placing a template in contact with the scaffold assembly, the template including a first shell with at least one cavity configured to receive a tooth, the first shell having a plurality of walls defining the at least one cavity, the plurality of walls being configured to conform to at least portions of one or more surfaces of the tooth, at least one of the plurality of walls includes a receptacle that is open to the at least one cavity, wherein placing includes inserting the attachment into the receptacle; and
separating the attachment from the one or more pillars and/or spars, wherein during separating, the attachment remains coupled to the template in the receptacle.

12. The method of claim 11, wherein constructing the scaffold assembly includes 3-D printing the scaffold assembly.

13. The method of claim 11, wherein the one or more pillars and/or spars extend at a non-orthogonal angle relative to the base.

14. The method of claim 11, wherein placing the template includes orienting the template at a nonorthogonal angle relative to the base so that the attachment is received in the receptacle.

15. The method of claim 11, wherein placing the template includes temporarily adhesively bonding the attachment in the receptacle.

16. The method of claim 11, wherein the scaffold assembly includes a weakened region between the attachment and the one or more pillars and/or spars and separating includes disconnecting the one or more pillars and/or spars from the attachment at the weakened region.

17. The method of claim 11, wherein separating includes cutting the one or more pillars and/or spars proximate the attachment.

18. The method of claim 11, further comprising:
providing a second shell with at least one cavity configured to receive the tooth, the second shell having a plurality of walls defining the at least one cavity, the plurality of walls being configured to conform to at least portions of one or more surfaces of the tooth; and
machining a window in at least one of the plurality of walls, the window being positioned to expose a surface of the tooth when the shell is positioned on the patient's teeth.

19. The method of claim 11, further comprising:
providing a plurality of aligners for use by the patient.

20. A method of manufacturing an orthodontic appliance system for use in orthodontic treatment of a patient, the method comprising:
providing a mold of the patient's teeth, the mold having at least one projection in the shape of at least one of the patient's teeth, the at least one projection including a through-passage;
placing a container of dental composite in fluid communication with the through-passage;
placing a template over the at least one projection, the template including a shell with at least one cavity configured to receive a tooth, the shell having a plurality of walls defining the at least one cavity, the plurality of walls being configured to conform to at least portions of one or more surfaces of the tooth, at least one of the plurality of walls includes a receptacle that is open to the at least one cavity, wherein placing includes positioning the receptacle in alignment with the through-passage;
injecting dental composite from the container through the through-passage and into the receptacle; and
removing the template from the at least one projection with the filled receptacle.

21.-23 (canceled)
